(19) United States
(12) Patent Application Publication
(10) Pub. No.: US 2026/0305510 A1
(43) Pub. Date: Oct. 8, 2026

(54) THINNING ELEMENTS OR SCOURGES FOR THINNING MACHINES AND RELATED THINNING MACHINE

(71) Applicant: B.M.V. S.R.L., ALBA (CN) (IT)

(72) Inventor: Stefano BORIO, ALBA (CN) (IT)

(21) Appl. No.: 19/482,029

(22) PCT Filed: May 7, 2024
(86) PCT No.: PCT/IB2024/054418

§ 371 Date: Nov. 6, 2025

(30) Foreign Application Priority Data
May 9, 2023 (IT) 102023000009243

(51) Int. Cl. A01B 41/04

(52) U.S. Cl. CPC A01B 41/04

(57) ABSTRACT

A thinning element for thinning machines thins vegetative elements protruding from branches of plants such as fruit trees. The thinning element includes a connection portion for connecting the thinning element to the thinning machine. A core extends from the connection portion along a longitudinal axis defining the longitudinal extension of the thinning element. A sheath is arranged around and envelops the core along the longitudinal axis. The core includes bodies shaped and constructed to provide the thinning element sufficient rigidity to ensure selective removal of vegetative elements, and sufficient resistance to end loads. The sheath has pliable portions along the longitudinal extension of the thinning element. The core has a longitudinal spring constant greater than 50 N/m, and the thinning element has a longitudinal spring constant greater than 180 N/m. The pliable portions flex when the thinning element hits branches of vegetable plants and/or vegetative elements and prevents damage.

The present invention relates to a scourge, a tooth, a stem or, more generally, a thinning element to be applied to a thinning machine for selectively thinning out flowers and/or fruits of a vegetable plant.

The present invention also relates to a thinning machine for selectively thinning out flowers and/or fruits of a vegetable plant.

It is known that selective thinning of flowers and/or (unripe) fruits improves the ripening and quality of the remaining fruits, so that higher-quality fruits can be obtained despite lower productivity in terms of total number and/or weight.

It must be pointed out that fruit harvesting or picking machines, as well as sucker removing machines, are designed to exert an invasive action on the vegetable plant, so as to completely remove all vegetative elements from the vegetable plant; therefore, such technology is would be hardly applicable for selectively thinning out vegetative elements, particularly buds and flowers.

As far as harvesting and picking machines are concerned, patent application EP1649740A1 discloses shaking fingers of movable combs of harvesting apparatus for small fruits, and harvesting machines which employ such fingers, wherein each finger has a rigid rod whose active part is provided with an elastic cover. The cover has longitudinal cavities consisting of holes arranged in the thickness of the cover around its central tubular part, between the central part and the periphery of the cover. The holes are separated by flexible partitions having a spiral section and connecting the part with an outer tubular part.

It is also known from patent U.S. Pat. No. 3,574,386A a grasping finger for use in apparatus adapted to grasp discrete articles disposed between a plurality of such elements, comprising an elongated substantially rigid support, a distendable elongated envelope having an outer grasping portion circumscribing said support and of a length substantially coextensive therewith, and tie means within the envelope interconnecting said portion and said support for limiting the extent to which said envelope can be radially displaced from said support.

Several types of flower and/or fruit thinning machines are known in the art. For example, document FR2965702 discloses a device having a drum mounted freely in rotation with a vertical rotation axis, and connected on a displacement unit, e.g. a tractor, and equipped with working arms driven in rotation. Such arms carry a wire. The wire is radially assembled with respect to the arm. The drum includes two faces, where the arms are assembled and fixed in angular displacement with respect to the corresponding faces.

Patent application CN103404379 discloses a self-propelled intelligent flower thinning machine for an orchard. The flower thinning unit is mainly composed of a flower thinning motor, a coupler, a rotation shaft, and flower thinning plastic strips. Such thinning machine is capable of adjusting the operation height and angle of the flower thinning unit, and adjusting the number and position of the flower thinning strips according to the types of fruit trees to be thinned out. According to this solution, the strips move relative to the axis of rotation of the drum whereon the arms are mounted. The same strips are not moved continuously relative to another axis to ensure a regular thinning action. Moreover, this document is mostly focused on the vehicle, not on the features of the thinning device.

Lastly, flower and fruit thinning machines are known from patent applications EP3569057A1 and EP3821696A1, which include at least one first mechanism, at least adapted to cause the body and the thinning elements or scourges to rotate in a controlled and assisted manner relative to an axis; and at least one second mechanism, adapted to cause each thinning element or scourge to oscillate relative to the external structure of the body. The oscillation of the thinning elements or scourges improves the removal activity in a simple and reliable manner.

In this field, the need is generally and increasingly felt for equipment ensuring effective but selective removal, while at the same time not damaging or ruining the flowers and/or fruits remaining on the vegetable plant.

Furthermore, the current state of the art suffers from the problem that the thinning elements or scourges should be able to withstand the strains caused by the forward motion of the thinning machine, e.g. when the thinning elements hit the vegetable plant and/or get stuck, without breaking. In particular, failures of such thinning elements or scourges have been observed to occur during the normal operation of the machine, due to said thinning elements hitting or sticking into parts of the plant and/or row of plants. The need has therefore emerged for making said thinning elements or scourges capable of resisting compression forces exerted along their extension axis, or end loads. At the same time, said thinning elements must be able to perform selective thinning without damaging the vegetable plant and/or the fruits and/or flowers remaining on the vegetable plant.

The need is therefore felt for providing thinning elements or scourges which allow for selective removal of vegetative elements protruding from branches of vegetable plants while not damaging the remaining vegetative elements, wherein such thinning elements or scourges are durable and strong, and d also capable of withstanding mechanical stresses.

The present invention aims at solving the problems suffered by the prior art by proposing an innovative solution for constructing thinning elements or scourges allowing for selective removal of vegetative elements protruding from branches of vegetable without damaging the vegetative elements remaining on the branches of the vegetable plants, even when said thinning elements or scourges hit the plants, wherein said thinning elements or scourges are resistant to breakage.

One aspect of the present invention relates to a thinning element or scourge having the features set out in the appended claim 1.

A further aspect of the present invention relates to a thinning machine having the features set out in the appended claim 11.

The features and advantages of the thinning element or scourge and of the machine will become apparent from the following description of several possible embodiments thereof, provided herein by way of non-limiting example, as well as from the annexed drawings, wherein:

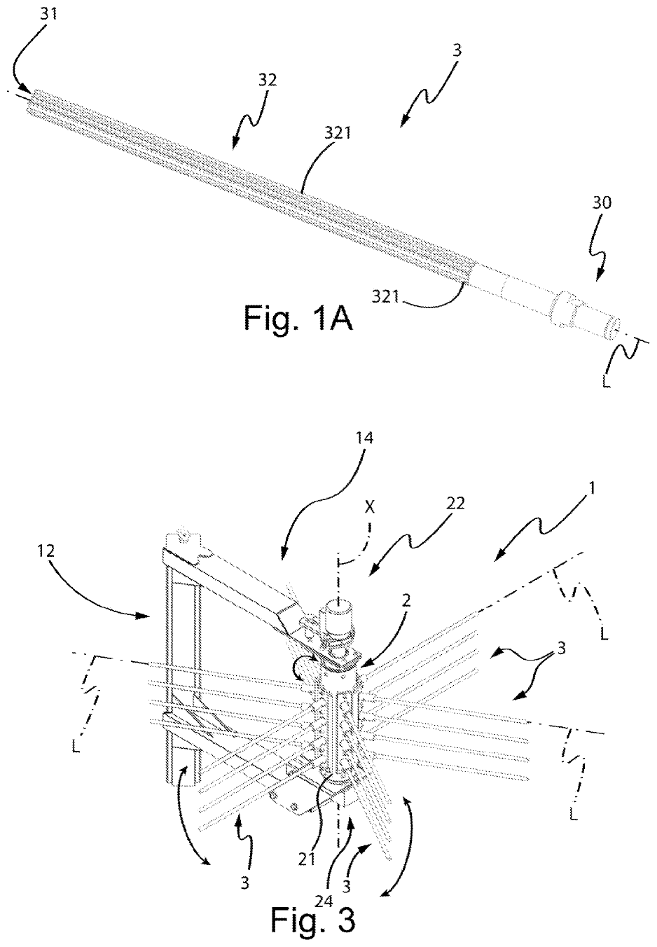

FIGS. 1A and 1B show different views of one possible embodiment of a thinning element or scourge:

FIG. 1A shows an axonometric view of the thinning element; FIG. 1B shows an exploded view of the thinning element;

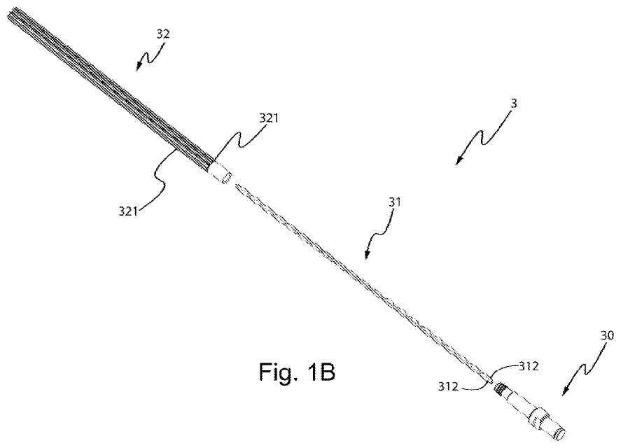

FIGS. 2A, 2B and 2C show different views of one possible embodiment of the thinning element or scourge; FIG. 2A shows a front view of the thinning element or scourge in axis with the longitudinal extension of the thinning element; FIG. 2B shows a sectional view of the thinning element or scourge in a plane 2B-2B along the longitudinal axis of the thinning element; FIG. 2C shows a sectional view of the thinning element or scourge in a plane 2C-2C perpendicular to the longitudinal axis of the thinning element;

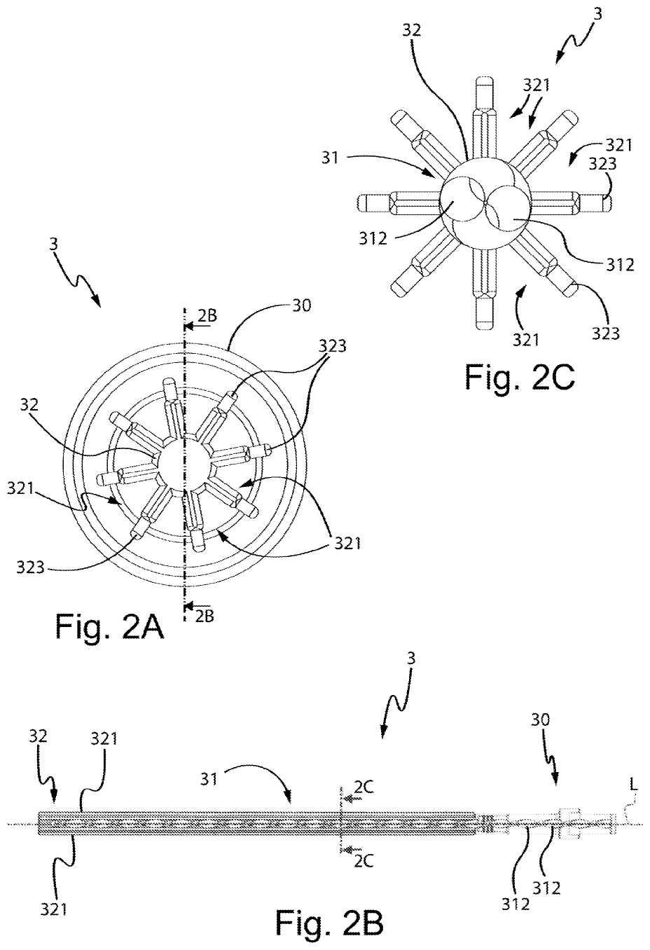

FIG. 3 shows an axonometric view of one possible embodiment of a thinning machine comprising a plurality of thinning elements or scourges.

With reference to the above-mentioned figures, reference numeral 3 designates as a whole the thinning element or scourge.

Reference numeral 1 designates a thinning machine as a whole, or at least a portion thereof.

Thinning element or scourge 3 is particularly suitable for application to thinning machines 1 adapted for thinning out vegetative elements, such as flowers and/or fruits, protruding from branches of vegetable plants, in particular 25 fruit trees.

Said thinning element 3 according to the present invention comprises: a connection portion 30, adapted to allow thinning element 3 to be connected to thinning machine 1; a core 31, extending from said connection portion 30 along a longitudinal axis “L” that defines the longitudinal extension of thinning element 3; and a sheath 32, arranged around said core 31 along said longitudinal axis “L”, which envelops said core 31, in particular that part of core 31 which protrudes from connection portion 30. Said core 31 comprises one or more bodies 312. Said one or more bodies are so shaped and constructed as to give thinning element 3 sufficient rigidity to ensure a selective removal of vegetative elements, as well as sufficient resistance to end loads.

Said sheath 32 comprises a plurality of pliable portions 321. Said pliable portions 321 are distributed along the extension of thinning element 3, defined by said longitudinal axis “L”.

Said pliable portions 321 are adapted to deform, in particular elastically, when thinning element 3 hits branches of vegetable plants and/or vegetative elements, thus preventing damage thereto.

Thinning element 3 can selectively remove vegetative elements without damaging the branches and/or those vegetative elements which remain attached to the branches of the vegetable plants, in addition to remaining intact even when subjected to end loads.

For the purposes the of present description, experimental tests were conducted in order to define the rigidity of said core 31 and of said one or more bodies 312 comprised therein, wherein said thinning element 3 was constrained at one end, e.g. at said connection portion 30, and forces were applied near the opposite end to assess the forces necessary to obtain different displacements along the direction of application of said forces, in particular forces applied along a vertical axis perpendicular to said longitudinal axis “L” of thinning element 3.

More specifically, several possible embodiments of thinning elements 3 were used in the tests. In particular, the tests were carried out on thinning elements 3, or parts thereof, having different types of cores 31, with a fixed length of 60 cm. In particular, thinning element 3 was constrained at connection portion 30 and, at a distance of 50 cm from the constraint point, the weights necessary to obtain displacements of 5 cm, 10 cm and 15 cm along said vertical axis were measured. Subsequently, the forces were determined.

The results are summarized in the following table:

| | | | |
|---|---|---|---|
| Type of thinning element | 5 cm | 10 cm | 15 cm |

| | | | | | |
|---|---|---|---|---|---|
| Two-body core | 1 | kg | 1.71 | kg | 2.53 Kg |
| Eq. diameter 4 cm | | | | | |
| with sheath | | | | | |
| One-body core | 1.22 | Kg | 2.30 | Kg | 3.30 Kg |
| Eq. diameter 5 cm | | | | | |
| with sheath | | | | | |
| Two-body core | 0.45 | Kg | 1.30 | Kg | 2.10 Kg |
| Eq. diameter 4 cm | | | | | |
| without sheath | | | | | |
| Two-body core | 0.03 | Kg | 0.1 | kg | 0.63 Kg |
| Eq. diameter 2.5 cm | | | | | |
| without sheath | | | | | |

By way of non-limiting example, based on such tests it was inferred that when using a core 31 having a longitudinal spring constant greater than 50 N/m, preferably greater than 80 N/m, even more preferably greater than 140 N/m, said core 31 could provide the desired selective thinning action together with an adequate level of end-load resistance.

Furthermore, the same tests showed that by using thinning element 3 according to the present invention having a longitudinal spring constant greater than 180 N/m, preferably greater than 220 N/m, the desired thinning action and an adequate level of end-load resistance could be obtained from the whole thinning element 3.

Referring back to the possible embodiments of thinning element 3 according to the present invention, according to a preferred embodiment said bodies 312 are at least two in number. The present embodiment makes it possible to obtain a desired rigidity, in particular a desired minimum rigidity, e.g. by varying the equivalent diameters of bodies 312, as necessary. Moreover, the use of two bodies reduces the risks of failure of thinning element 3, e.g. when it gets stuck and/or is subjected to end loads.

Preferably, said one or more bodies 312 are made of metal material, e.g. steel, harmonic steel, titanium or aluminium alloys. The present embodiment further reduces the risk of failure of thinning element 3, and particularly of core 31, e.g. when it gets stuck and/or is subjected to end loads, while providing a desired degree of rigidity, e.g. a desired minimum rigidity.

As an alternative, said one or more bodies 312 are made of high-rigidity material, such as, for example, carbon fiber and fiberglass.

Preferably, each one of said bodies 312 is bar-shaped. Preferably, each body 312 has a circular cross-section. The present embodiment ensures a more uniform behaviour of core 31, permitting the achievement of the desired degree of rigidity even when thinning element 3 is subject to forces coming from different directions.

In a preferred embodiment of thinning element according to the present invention, said at least two bodies 312 are arranged in a helical spiral fashion. The present embodiment provides the best trade-off between desired minimum rigidity and end-load resistance.

In a preferred embodiment, said bodies 312 of core 31 are two in number, and are arranged in a helical double-spiral fashion. The twisted disposition of bodies 312 of core 31 is useful to prevent failures induced by end loads and to increase the rigidity of core 31.

In an even more preferable embodiment, said code 31 comprises two bodies 312 made of metal material, e.g. steel, and having a circular cross-section, arranged in a helical double-spiral fashion. The present embodiment compensates for the inherent flexibility of metal materials to obtain the desired minimum rigidity, while ensuring higher end-load resistance and considerably reducing the risk of failure of thinning element 3, and particularly of said core 31.

In a preferred embodiment of thinning element 3 according to the present invention, said connection portion is adapted to allow the transmission of motion from said thinning machine 1 to said core 31.

Preferably, said core 31 is so shaped as to prevent the motion imparted by thinning machine 1 and impacts of thinning element 3 against vegetable plants from causing resonant oscillations of said core 31. In addition to preventing the application of a force sufficient to selectively remove vegetative elements, such resonant oscillations could also impair the stability of thinning element 3, and hence of whole thinning machine 1.

In particular, the rigidity of core 31 avoids the triggering of resonant oscillations. Moreover, the embodiment comprising two bodies 312 further reduces the risk of resonant oscillations.

Furthermore, the embodiment wherein bodies 312 are arranged in a helical spiral fashion further reduces the risk of resonant oscillations.

More generally, said connection portion 30 ensures a stable and strong connection between thinning element 3 and thinning machine 1.

For example, said connection portion 30 connects thinning element 3 to thinning machine 1 by shape coupling, joint connection, bayonet connection, or other types of connections, such as to a ensure proper mechanical connection and a proper transmission of motion from thinning machine 1 to thinning element 3, while also avoiding the propagation of undesired vibration from thinning element 3 to thinning machine 1.

Preferably, said connection portion 30 is made of plastic material, preferably a rigid, non-deformable material.

In one possible embodiment of thinning element 3 according to the present invention, said pliable portions 321 are protrusions projecting from said sheath 32.

In a preferred embodiment, said protrusions 321 extend radially from said longitudinal axis “L”,

Said pliable portions 321 or protrusions may have an annular shape and jut out from said sheath 32. In this embodiment, said pliable portions are spaced apart, e.g. at regular intervals, along longitudinal axis “L” of thinning element 3.

In a preferred embodiment, each protrusion 321 extends parallel to said longitudinal axis “L”. The present embodiment provides protrusions 321 disposed around the circumference of sheath 32, e.g. angularly spaced apart at regular intervals from each other.

In a further preferred, but merely illustrative and non-limiting, embodiment, each protrusion 321 extends along the longitudinal extension of thinning element 3 in a spiral or helix fashion relative to said longitudinal axis “L”. The present embodiment provides protrusions 321 that are prone to deforming upon impact, thus further reducing the risk of damage to the vegetative elements.

More generally, said protrusions 321 are advantageously so arranged as to be able to deform when they hit vegetative elements that remain attached to the plant under the action of thinning element 3, thus causing no damage to such vegetative elements.

More generally, said protrusions 321 may have any shape, extension and/or disposition relative to said longitudinal axis “L”, since they may have either a continuous conformation, e.g. the previously described conformations, or a discontinuous conformation still providing the above-described conformations, which will be fragmented as opposed to continuous.

In one possible embodiment of sheath 32 of thinning element 3 according to the present invention, each protrusion 321 comprises at least one free end 323 adapted to flex upon impact. The present embodiment makes it possible to shape each protrusion 321 in such a way that it can deform by gradually flexing starting from said end 323.

In a preferred embodiment, the thickness of said end 323 of protrusion 321 is smaller than the thickness of the protrusion in proximity to the surface of sheath 32 from which it extends.

The variation in the thickness of each protrusion 321, from the base to said end 323, may be either continuous, e.g. with a linear or exponential tapered profile, or discontinuous, e.g. with one or more steps. This latter embodiment provides weaker points useful to ensure that protrusion 321 will deform, in particular that end 323 thereof will flex, upon impact.

In a preferred embodiment of thinning element 3 according to the present invention, said sheath 32 is made of a material which can elastically deform while being resistant to wear from friction and/or shock loads, e.g. polyurethane. The present embodiment ensures a long service life of each thinning element 3, which will last many working hours. In particular, by using polyurethane it is possible to obtain a sheath 32, and particularly the pliable portions or protrusions 321, having the desired flexibility, being able to deform elastically, and ensuring the desired resistance to wear from friction and/or shock loads.

Preferably, said sheath 32 protrudes beyond the distal end of core 31, which is the end opposite to the end extending from said connection portion 30. Such a solution makes it possible to attenuate any forces applied along the longitudinal axis of core 31, contributing to reducing the risk of failure under end loads.

In a preferred embodiment of thinning element 3 according to the present invention, it is manufactured by means of a co-moulding process. For example, during said co-moulding process, core 31 made according to the desired embodiment is placed into a mould, where said connection portion 30 is then formed, e.g. by injection, and subsequently, still by injection, sheath 32 is formed. Advantageously, said sheath 32 is so designed as to envelop also a part of said connection portion 30, in order to prevent sheath 32 from slipping off core 31.

In general, said thinning element 3 has a length, along said longitudinal axis “L”, which may vary according to the type of thinning machine 1 with which it is to be associated. For example, when said thinning element 3 is to be applied to a thinning machine 1 adapted to work on vegetable plants arranged in rows and having no crown, said thinning elements 3 may have a length shorter than or equal to approximately 60 cm.

On the contrary, when said thinning element 3 is to be applied to a thinning machine 1 adapted to work on vegetable plants having a projecting crown, said thinning elements 3 may have a length greater than or equal to approximately 60 cm.

In a preferred embodiment, described herein merely as an illustrative and non-limiting example, said thinning element 3 comprises a sheath 32 having a plurality of protrusions 321, e.g. six or more protrusions 321, extending parallel to said longitudinal axis “L” at a regular angular distance. Each protrusion 321 has a free end 323, which is thinner and adapted to flex upon impact. Said sheath 32 is made of polyurethane and, when viewed in alignment with the longitudinal extension of thinning element 3, is shaped as a star having six or more points.

FIGS. 1A and 1B show different views of one possible embodiment of a thinning element or scourge 3. In particular, FIG. 1A shows an axonometric view of thinning element 3. In this figure, one can see that said thinning element 3 extends along a longitudinal axis “L”, and that at one end thereof there is the connection portion 30, which is adapted to be removably fastened to a thinning machine by means of a shape-coupling connection system. Said thinning element 3 further comprises a sheath 32, from which a plurality of protrusions 321 jut out. Though not directly visible in the drawing, said core 31 extends within sheath 32 along said longitudinal axis “L”.

FIG. 1B shows an exploded view of thinning element or scourge 3. This figure clearly shows that said thinning element 3 comprises a core 31 in addition to said connection portion 30 and said sheath 32. In the illustrated embodiment, said core 31 comprises two bodies 312, which are arranged in a helical double-spiral fashion. In FIG. 1B one can also see protrusions 321 comprised in the sheath 32.

FIG. 2A shows a front view of thinning element or scourge 3 in axis with the longitudinal extension of thinning element or scourge 3. In FIG. 2A one can see the eight-pointed star shape of sheath 32, which comprises eight pliable portions 321 in the form of protrusions jutting out radially and extending parallel to the longitudinal axis at a regular angular distance. Each protrusion 321 comprises a free end 323, which can flex when forces are applied to such protrusions 321. In FIG. 2A one can also see a part of connection portion 30 that makes it possible to connect the thinning element or scourge 3 according to the present invention to a thinning machine.

FIG. 2B shows a sectional view of the thinning element or scourge 3 in a plane 2B-2B along longitudinal axis “L” of thinning element or scourge 3. In FIG. 2B one can see that thinning element 3 develops along said longitudinal axis “L”, and that at one end thereof there is said connection portion 30, from which said core 31 extends. The embodiment illustrated in FIG. 2B can clearly be realized by means of a co-moulding process, wherein core 31 is first enveloped by said connection portion 30 and then enveloped by said sheath 32. Said sheath 32 comprises a plurality of pliable portions 321 in the form of protrusions. FIG. 2B clearly shows that said core 31 comprises two bodies 312 twisted together in a helical double-spiral fashion. In FIG. 2B it is possible to see that said sheath 32 extends beyond the distal end of core 31, which is the end opposite to the end where there is said connection portion 30.

FIG. 2C shows a sectional view of the thinning element or scourge in a plane 2C-2C perpendicular to longitudinal axis “L” of thinning element or scourge 3. In FIG. 2C one can clearly see that said protrusions 321 extend radially from said sheath 32 and, as can be easily inferred, extend along the longitudinal extension of thinning element 3, parallel to said longitudinal axis “L” of thinning element 3. FIG. 2C shows that said bodies 312 of core 31 are arranged in a helical spiral fashion and buried in sheath 32, e.g. by means of a co-moulding process. In the embodiment illustrated in FIG. 2C there are eight protrusions 321, disposed at a regular angular distance. Also, each protrusion 321 comprises an end 323 which is thinner than the remaining part of protrusion 321 to facilitate the bending of the same upon impact.

Thinning element or scourge 3 is particularly suitable for application to thinning machines 1. A thinning machine 1 according to the present invention is adapted for thinning out vegetative elements protruding from branches of vegetable plants, in particular fruit trees.

As is known to a person skilled in the art, the thinning process is different and dissimilar from the process of knocking down or picking fruits, e.g. mature fruits.

Said thinning machine 1 according to the present invention comprises: a main frame 12, which is adapted to be connected to a vehicle, in particular an agricultural tractor; and a support frame 14.

Said thinning machine 1 further comprises a body 2, which extends substantially along a second axis “X” and comprises an external structure 21. Said body 2 is suitably connected to said support frame 14.

Said thinning machine 1 further comprises a plurality of thinning elements or scourges 3, adapted to act upon vegetative elements for thinning them out. Said thinning elements 3 project from said body 2, thereby defining a respective longitudinal axis “L”.

Said thinning machine 1 further comprises a drive system 22 adapted to move said body 2 and said thinning elements 3.

In a preferred embodiment of thinning machine 1 according to the present invention, said drive system 22 comprises at least one mechanism 24 adapted to cause each thinning element 3 to oscillate relative to said external structure 21 of body 2. In particular, said mechanism 24 is adapted to cause each thinning element 3 to oscillate about a respective axis. Said axis is substantially perpendicular to longitudinal axis “L” of each thinning element 3. The present embodiment facilitates the thinning of vegetative elements protruding from branches of vegetable plants, because the oscillating action of thinning elements 3 makes for more effective and reliable thinning. The oscillation of said thinning elements 3 increases the risk of breakage of the thinning elements according to the prior art. Thinning elements 3 according to the present invention, on the contrary, translate such oscillation into an effective action upon the branches and the vegetative elements, ensuring that the vegetative elements that remain attached to the branches, although hit by thinning elements 3, will undergo no damage that may jeopardize their evolution into fruits and/or their proper ripening and aesthetical appearance, in addition to avoiding that end loads, e.g. caused by sticking, might break said thinning elements 3.

In one possible embodiment of thinning machine 1 according to the present invention, said drive system 22 is at least adapted to rotate, in a controlled and assisted manner, and particularly not in free or idle rotation, at least said body 2 and said thinning elements 3 relative to said second axis “X”.

In a preferred embodiment, described herein merely as an illustrative and non-limiting example, said mechanism 24 comprises: a shaft, which extends along said second axis “X” and is adapted to rotate about said second axis “X”. In one possible embodiment, said mechanism 24 is connected between said shaft and said thinning elements 3, and is adapted to cause each thinning element 3 to oscillate 3. In a preferred embodiment, said connection portion 30 of thinning element 3 is adapted to be pivoted to external structure 21, so that said thinning element 3 can oscillate about a pivot axis.

In a preferred, but merely illustrative and non-limiting, embodiment of thinning machine 1, the plurality of thinning elements 3 are divided into groups. Each group is fixed to a respective support structure, which is pivoted to external structure 21 so as to oscillate about a pivot axis.

In a preferred, but merely illustrative and non-limiting, embodiment of thinning machine 1, said mechanism 24 comprises: a plurality of eccentric elements suitably arranged along said shaft; and a plurality of rods, each one connected to a respective eccentric element and protruding along a direction substantially perpendicular to said shaft. Said mechanism 24 further comprises a plurality of connection kinematic systems, each one connected to a rod at one end and to at least one thinning element 3 at the opposite end. In particular, the rotary motion of said shaft is suitably converted by said mechanism 24 into oscillation of said thinning elements 3.

In a preferred, but merely illustrative and non-limiting, embodiment of thinning machine 1, said mechanism 24 is designed to move said thinning elements 3 in a discordant manner, but in static equilibrium.

The present invention makes it possible to exert a force on the vegetative elements of a vegetable plant in order to attain selective thinning, while at the same time ensuring that the vegetative elements that remain attached to the branches of the vegetable plant, although hit by thinning element 3, will bear no traces of such impact, so that during their evolution they will not suffer from any adverse consequences in their structure, growth, and aesthetic and visual appearance.

Thinning element 3 according to the present invention solves the technical problem suffered by prior-art thinning machines 1 whose thinning elements 3 break under end loads. The present invention provides an effective and uniform action upon branches and vegetative elements, while reducing the risk of failure of said thinning elements 3 due to end loads.

The present invention also makes it possible to obtain a desired minimum rigidity of thinning element 3, and particularly of core 31, thus reducing the risk of failure due to, for example, end loads.

Thinning element 3 according to the present invention, and hence thinning machine 1, make it possible to obtain a thinning rate of 10% to 50%, preferably 20% to 40%.

Thinning element or scourge 3 according to the present invention provides effective and selective removal without damaging the flowers and/or fruits remaining on the vegetable plant, thanks to the rigidity of core 31 and to sheath 32 that envelops said core 31. Thinning elements or scourges 3 can withstand strains caused by the forward motion of thinning machine 1, by impacts against the vegetable plants, and/or by any thinning element or scourge 3 getting stuck, resulting in end loads being applied to said thinning element 3.

In order to be able to provide selective thinning, thinning elements or scourges 3 according to the present invention are, preferably, as rigid as possible. Also, thinning elements or scourges 3 according to the present invention cause no damage to the vegetable plant and/or to the fruits and/or flowers remaining on the vegetable plant. Moreover, said thinning or elements scourges 3 can withstand strains, without breaking, during the normal operation of thinning machine 1. For example, they can resist impacts or binding with parts of the plant and/or row, withstanding compression forces exerted along the axis of extension of thinning element or scourge 3, also referred to as end loads.

Any embodiments which have not been described herein, but which can be easily inferred by a person skilled in the art in light of the present description and the annexed drawings, shall be considered to fall within the protection scope of the present invention.

REFERENCE NUMERALS

| | |
|---|---|
| Thinning machine | 1 |
| Main frame | 12 |
| Support frame | 14 |
| Body | 2 |
| External structure | 21 |
| Drive system | 22 |
| Mechanism | 24 |
| Thinning element or scourge | 3 |
| Connection portion | 30 |
| Core | 31 |
| Bodies | 312 |
| Sheath | 32 |
| Pliable portions | 321 |
| End | 323 |
| Longitudinal axis | “L” |
| Second axis | “X” |

1. A thinning element for thinning machines adapted for thinning out vegetative elements protruding from branches of vegetable plants; said thinning element comprising:
a connection portion adapted to allow the thinning element to be connected to the thinning machine;
a core extending from said connection portion along a longitudinal axis that defines a longitudinal extension of the thinning element;
a sheath, arranged around said core along said longitudinal axis, which envelops said core; said sheath comprising a plurality of pliable portions distributed along the longitudinal extension of the thinning element;
said core comprises one or more bodies se shaped and constructed to give the thinning element sufficient rigidity to ensure a selective removal of vegetative elements, as well as sufficient resistance to end loads;
said core having a longitudinal spring constant greater than 50 N/m, and said thinning element having a longitudinal spring constant greater than 180 N/m;
said pliable portions being adapted to flex when the thinning element hits branches of vegetable plants and/or vegetative elements.

2. The thinning element according to claim 1, comprising at least two of said one or more bodies, and are made from bar-shaped metal material.

3. The thinning element according to claim 2, wherein said at least two bodies are arranged in a helical spiral fashion.

4. The thinning element according to claim 1, wherein said connection portion is adapted to allow transmission of motion from said thinning machine to said core, the core being shaped to prevent the motion imparted by the thinning machine and impacts of the thinning element against the vegetable plant from causing a resonant oscillation of said core.

5. The thinning element according to claim 1, wherein said pliable portions being comprise protrusions projecting from said sheath.

6. The thinning element according to claim 5, wherein said protrusions extend radially from said longitudinal axis.

7. The thinning element according to claim 6, wherein each protrusion extends parallel to said longitudinal axis.

8. The thinning element according to claim 6 or 5, wherein each protrusion extends along the longitudinal extension of the thinning element in a spiral or helix fashion, relative to said longitudinal axis.

9. The thinning element according to claim 6, wherein each protrusion comprises at least one free end adapted to flex upon impact.

10. The thinning element according to claim 1, said sheath being made of an elastically deformable material and being resistant to wear from friction and/or shock loads.

11. A thinning machine for thinning out vegetative elements protruding from branches of vegetable plants;
said thinning machine comprising:
a main frame, which is adapted to be connected to a vehicle;
a support frame;
a body, extending substantially along a second axis, comprising an external structure connected to said support frame;
a plurality of thinning elements or scourges, adapted to act upon vegetative elements for thinning the vegetative elements; said thinning elements (3) projecting from said body and defining a respective longitudinal axis;
a drive system adapted to move said body and said thinning elements;
said plurality of thinning elements or scourges comprising a plurality of the thinning elements according to claim 1.

12. The thinning machine according to claim 11, wherein said drive system comprises at least one mechanism adapted to cause each thinning element to oscillate relative to said external structure of the body about a respective axis, the respective axis being substantially perpendicular to the longitudinal axis of each thinning element.

13. The thinning element according to claim 1 wherein said sheath is made of an elastically deformable polyurethane material and is resistant to wear from friction and/or shock loads.
